(19) United States
(12) Patent Application Publication
(10) Pub. No.: US 2025/0307846 A1
(43) Pub. Date: Oct. 2, 2025

(54) SYSTEM AND METHOD FOR AUTHENTICATING A PRODUCT

(71) Applicant: STMicroelectronics International N.V., Geneva (CH)

(72) Inventors: Sophie MAURICE, Biviers (FR); Romain PARDO, Coudoux (FR); Julien TERRIER, Saint Zacharie (FR)

(21) Appl. No.: 19/080,383

(22) Filed: Mar. 14, 2025

(30) Foreign Application Priority Data
Mar. 29, 2024 (FR) FR2403320

(51) Int. Cl. G06Q 30/018; H04L 9/00; H04L 9/30

(52) U.S. Cl. CPC G06Q 30/0185; H04L 9/3073; H04L 9/50; G06Q 2220/127

(57) ABSTRACT

The present description concerns a method of recording a link between a radio frequency tag and a token comprising data associated with a product. An example method comprising: sending, by near-field communication or radio identification, of data of a transaction by an electronic device to the tag; generating of a signature by the tag based on a private key of an asymmetric pair of keys further comprising a public key, the signature being configured to enable a recording on a blockchain; transmitting by the tag of the signed transaction to the electronic device by NFC or RFID; and immutable recording of the link between the tag and the token by the transmission, by the electronic device, of the signed transaction to a server implementing the blockchain.

### CROSS REFERENCE TO RELATED APPLICATIONS

This application claims the priority benefit of French patent application number FR2403320, filed on Mar. 29, 2024, entitled “Système et procédé d'authentification d'un produit”, which is hereby incorporated by reference to the maximum extent allowable by law.

### TECHNICAL FIELD

The present disclosure generally concerns a system and a method for authenticating a product and in particular blockchain-based solutions.

### BACKGROUND

For certain products, it may be desirable to provide an authentication system enabling to control the origin and the traceability of these products. To answer this need, it has been proposed to paste a QR code on a product, enabling to authenticate the product by means of a reader. However, a disadvantage with this solution is that a QR code is likely to be damaged and thus to become illegible during the lifetime of the product. Another provided solution is to integrate an electronic circuit to the product. The electronic circuit is capable of communicating with an external electronic device by wireless communication means, for example wifi or Bluetooth, in order to read information stored by the electronic circuit and to authenticate the product based on this information.

However, existing solutions are generally complex, costly, insufficiently secure, and/or require a battery, and there thus exists a need for an improved authentication solution.

### BRIEF SUMMARY

An embodiment provides a method of recording a link between a radio frequency tag and a token comprising data associated with a product, the method comprising:
the sending, by near-field communication (NFC) or radio frequency identification (RFID), of data of a transaction by an electronic device to the tag;
the generation of a signature of the data of the transaction by the tag based on a private key of an asymmetric pair of keys further comprising a public key, the signature being configured to enable a recording on a blockchain;
the transmission by the tag of the signed transaction to the electronic device by NFC or RFID; and
the immutable recording of the link between the tag and the token by the transmission, by the electronic device, of the signed transaction to a server implementing the blockchain.

According to an embodiment, the signature comprises three components generated by a cryptographic signature algorithm, the third component of which enables to identify the public key.

According to an embodiment, the signature comprises two components generated by a cryptographic signature algorithm, one of the components identifying the asymmetric pair of keys.

According to an embodiment, the recording of the link between the tag and the token comprises the execution by the server of scripts.

According to an embodiment, the sending of the transaction data by the electronic device is performed via an application, the application being implemented by the electronic device and the recording of the link being initiated by the application.

According to an embodiment, the generation of the signature is performed by an elliptic cryptography algorithm.

According to an embodiment, the blockchain is of Ethereum virtual machine type.

Another embodiment provides a system for recording a link between a radio frequency tag and a token comprising data associated with a product, the device comprising:
an electronic device configured to send, by NFC or by RFID, data of a transaction to the tag, and configured to transmit the transaction signed to a server implementing a blockchain; —the tag configured to generate a signature of the data of the transaction based on a private key, forming an asymmetric pair of keys further comprising a public key, the signature being configured to enable a recording on a blockchain, the tag being further configured to transmit, by NFC or by RFID, the signature to the electronic device, the electronic device being configured to transmit the signed transaction to the server implementing the blockchain and configured to immutably record the link between the tag and the token.

According to an embodiment, the signature comprises three components generated by a cryptographic signature algorithm, the third component of which enables to identify the public key.

According to an embodiment, the signature comprises two components generated by a cryptographic signature algorithm, one of the components identifying the asymmetric pair of keys.

According to an embodiment, the method further comprises the server.

According to an embodiment, the tag is attached or integrated to the product.

According to an embodiment, the data associated with the product are images and/or metadata.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1 shows, in the form of blocks, an authentication system according to an embodiment of the present disclosure;

FIG. 2 shows, in the form of blocks and in more detailed fashion, the tag 110 and the electronic device 130 of FIG. 1 in communication with a server 150, according to an embodiment of the present disclosure;

FIG. 3 shows steps of an example of a method of recording a link between a near-field communication (NFC) tag and a token according to an embodiment of the present disclosure;

FIG. 4 shows steps of another example of a method of recording a link between a tag and a token, according to an embodiment of the present disclosure;

FIG. 5 shows steps of an example of a method of registration of an owner of a product according to an embodiment of the present disclosure;

FIG. 6 shows steps of an example of a method of verification of the authenticity of a product according to an embodiment of the present disclosure; and

FIG. 7 shows the steps of an example of a method of verification of the belonging of a product according to an embodiment of the present disclosure.

### DETAILED DESCRIPTION

Like features have been designated by like references in the various figures. In particular, the structural and/or functional features that are common among the various embodiments may have the same references and may dispose identical structural, dimensional and material properties.

For clarity, only those steps and elements which are useful to the understanding of the described embodiments have been shown and are described in detail. In particular, a blockchain and its operation as well as near-field communication protocols are known to those skilled in the art and will not be detailed.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, where reference is made to absolute position qualifiers, such as “front”, “back”, “top”, “bottom”, “left”, “right”, etc., or relative position qualifiers, such as “top”, “bottom”, “upper”, “lower”, etc., or orientation qualifiers, such as “horizontal”, “vertical”, etc., reference is made unless otherwise specified to the orientation of the drawings.

Unless specified otherwise, the expressions “about”, “approximately”, “substantially”, and “in the order of” signify plus or minus 10%, preferably of plus or minus 5%.

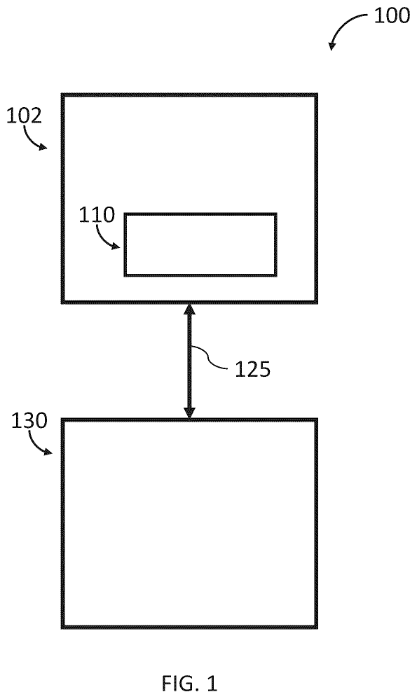

FIG. 1 shows, in the form of blocks, an authentication system 100 according to an embodiment of the present disclosure.

Authentication system 100 comprises a radio frequency tag 110 present on a product 102. For example, product 102 is a physical object, for example an object comprising no electronic circuitry. Product 102 is, for example, an item of clothing, an accessory, a consumer product, for example a bottle of alcohol, an ownership certificate, and so on.

Tag 110 is, for example, pasted or physically integrated to product 102 during its manufacturing and cannot, for example, be removed or modified. For example, the physical connection is achieved via an adhesive so that tag 110 is destroyed or damaged if it was removed from product 102.

Authentication system 100 also comprises an electronic device 130. Tag 110 is configured to communicate via a radio-frequency communication link, for example according to a near-field communication (NFC) or radio frequency identification (RFID) protocol 125, with electronic device 130. Electronic device 130 is for example a high-frequency NFC or RFID reader, a computer, a cell phone, a tablet, etc., equipped with a high-frequency NFC or RFID reader. Electronic device 130 is for example configured to implement a user interface, for example decentralized, for example a mobile application. Electronic device 130 is also configured to communicate with a remote server (not shown in FIG. 1) in order to implement a method of authentication of product 102 based on tag 110.

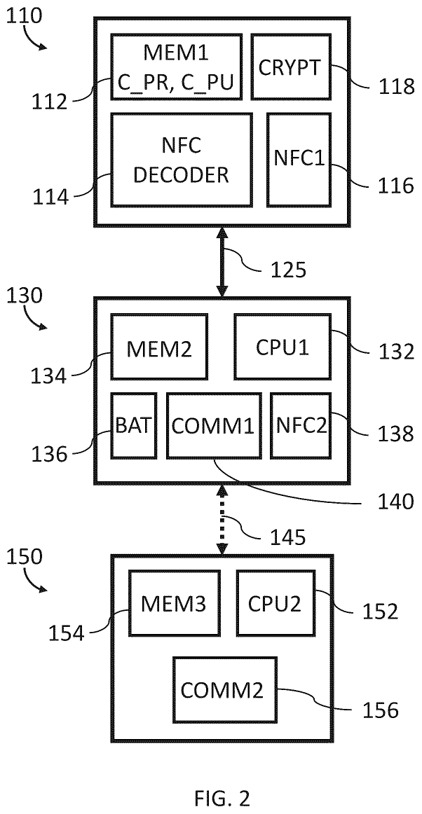

FIG. 2 shows, in the form of blocks and in more detailed fashion, the tag 110 and the electronic device 130 of FIG. 1 in communication with a server 150, according to an embodiment of the present disclosure.

The product 102 of FIG. 1 is not shown in FIG. 2 and only tag 110 is illustrated. Tag 110 comprises, for example, a memory 112 (“MEM1”). One or a plurality of pairs of keys, each comprising a private key C_PR and a public key C_PU, are for example generated by the manufacturer of tag 110, and are for example assigned to tag 110 and stored in memory 112.

Tag 110 also comprises an NFC decoder 114 (“NFC DECODER”) and an NFC interface 116 (“NFC1”) for example comprising an antenna configured to send and receive waves having a radio frequency compatible with an NFC communication and also for example comprising a conversion circuit (not shown) Block 114 and NFC interface 116 are configured so that tag 110 can communicate via an NFC link 125 with electronic device 130.

Tag 110 also comprises a cryptographic circuit 118 (“CRYPT”) configured to perform cryptographic operations, for example to calculate a hash value based on information relative to a transaction to be performed and/or to generate signatures based on the private key C_PR stored in memory 112.

Electronic device 130 comprises, for example, a central processing unit 132 (“CPU1”) configured to implement the mobile application, a memory 134 (“MEM2”), and a battery 136 (“BAT”). Electronic device 130 also comprises an NFC interface 138 (“NFC2”) comprising, for example, an antenna configured to receive and to send waves having a radio frequency compatible with an NFC communication and comprising, for example, a conversion circuit (not shown). Electronic device 130 also comprises a communication interface 140 (“COMM1”) comprising, for example, an antenna configured to receive and to send waves having a frequency compatible with a wireless communication, for example a wifi connection or a communication over a cellular network. Electronic device 130 is configured to communicate via an NFC or RFID link 125 with tag 110 and to communicate via a wireless link 145 with server 150 via communication interface 140 and, for example, one or a plurality of intermediate wireless or wired networks, such as the Internet.

Server 150 comprises, for example, a central processing unit 152 (“CPU2”), a memory 154 (“MEM”), and a communication interface 156 (“COMM2”) configured to receive and to transmit data to electronic device 130. Server 150 represents, for example, a node of a blockchain. In certain cases, the blockchain comprises a plurality of nodes (not illustrated), each formed by a server similar to server 150. Electronic device 130 communicates, for example, with an interface of server 150, which consists of a node making remote procedure calls (RPC) to server 150.

Tag 110, electronic device 130, and server 150 comprise, for example, other elements not illustrated in FIG. 2.

Embodiments provide immutably and irreversibly linking the tag 110 present on product 102 to a digital token TOKEN (not illustrated in FIG. 2), for example a non-fungible token (NFT) and/or a soulbound token.

In order to link token TOKEN to tag 110, a method is implemented comprising, during a first phase, the generation of a signature SIG1, generated by tag 110, and, during a second phase, the recording of the link on a blockchain based on signature SIG1.

This link enables to improve the traceability of product 102 from its manufacturing to a marketing or to successive marketing operations, and to better inform users about the supply chain of product 102.

According to an embodiment, digital token TOKEN is generated by a computer system belonging to the entity marketing product 102. Digital token TOKEN comprises, for example, images and/or metadata of product 102, for example, a picture of product 102, a name, a logo of the brand of product 102, the name of the creator, a description, a creation date, etc.

Server 150 corresponds, for example, to a node of the blockchain. Server 150 is for example configured to execute command scripts on the blockchain and to record transactions on the blockchain, into memory 154.

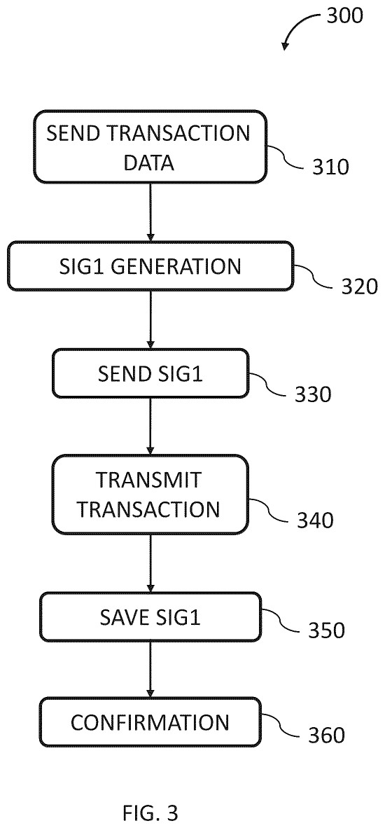

FIG. 3 shows steps of an example of a method 300 of recording a link between the tag 110 of FIG. 1 and token TOKEN according to an embodiment of the present disclosure.

The method is for example initiated by a user in possession of the product 102 of FIG. 1 and of electronic device 130. The user for example uses the mobile application implemented by electronic device 130 to initiate the method of recording the link between tag 110 and token TOKEN. This procedure is for example carried out only once, for example during the manufacturing of product 102 or before its marketing.

At a step 310 (“SEND TRANSACTION DATA”), the electronic device 130 of FIGS. 1 and 2 sends, by NFC, a signature request to tag 110, which receives it. The sending of the signature request is for example performed via the mobile application. The signature request is, for example, sent in hashed or serialized form by an encoding of the recursive length prefix (RLP).

According to an embodiment, the user, via electronic device 130, creates a transaction data structure for example comprising nine fields comprising a plurality of or all the following elements: a nonce, a gas price, a gas limit, a recipient, an amount, data, a identifier of the blockchain, and two fields each initialized to the zero value.

The nonce is for example a sequence number generated by an externally-owned account (EOA) and used to prevent a replay attack.

The gas price, for example, corresponds to the quantity of ether, in wei, that the user is willing to pay for one gas unit.

The gas limit corresponds, for example, to the maximum quantity of gas that the user is willing to pay for the transaction.

The recipient corresponds, for example, to a destination address, such as an EOA address or an address of a digital contract, such as a smart contract, on the blockchain.

The amount corresponds, for example, to the quantity of ether, in wei, to be sent to the recipient.

The data are, for example, variable-length binary data, for example, a function selector, for example the first 4 hash bits of a secure hash algorithm, for example, Keccak-256, and the variables of the function, for example related to the called smart contract.

The identifier of the blockchain is, for example, a unique identifier associated with a blockchain network comprising the blockchain.

The two fields initially comprising a zero, as a complement to the identifier of the blockchain, are for example used to secure the transaction and prevent replay attacks.

During step 310, the signature request sent by electronic device 130 for example comprises the data structure.

At a step 320 (“SIG1 GENERATION”) following step 310, tag 110 generates signature SIG1. For example, tag 110 generates signature SIG1 only if the transaction corresponds to an expected cryptographic algorithm, for example, an elliptic curve cryptography (ECC) algorithm, for example secp256k1, secp256r1, Keccak 256, SHA3-256, etc.

The block 118 CRYPT of tag 110 for example carries out a hash function, for example via the Keccak-256 algorithm, to generate a hash value corresponding to the signature request received from electronic device 130.

Signature SIG1 is for example generated by block 118 from the private key C_PR of tag 110, for example via an elliptic curve digital signature algorithm (ECDSA).

Signature SIG1 is configured to enable a recording on a blockchain. In particular, signature SIG1 comprises:
either two components r and s generated by a cryptographic signature algorithm, one of the components identifying the asymmetric pair of keys C_PU, C_PR. An example of such an algorithm is the Edwards-curve digital signature algorithm (EdDSA), for example Ed25519, the algorithm taking as an input the private key and the components r and s corresponding, for example, to coordinates on an elliptic curve. The EdDSA algorithm is described in more detail in the article entitled “Edwards-Curve Digital Signature Algorithm (EdDSA)” by S. Josefsson et al, the contents of which are incorporated herein by reference;
or three components r, s, and v generated by a cryptographic signature algorithm, for example an ECDSA algorithm, where the third component enables the identification of the public key C_PU, the third component for example corresponding to a signature prefix and/or to a recovery identifier. The third component v is such that the public key can be calculated from components r, s, and v. The third component v is for example also characteristic of the blockchain.

The generated signature SIG1, for example, complies with security protocols for elliptical-type blockchains and can be used directly to sign transactions on the blockchain, without requiring an intermediate procedure of conversion of signature SIG1.

At a step 330 (“SEND SIG1”) following step 320, tag 110 transmits, by NFC, signature SIG1 to electronic device 130. Electronic device 130, for example, adds signature SIG1 to the data structure to sign transaction T1. The third component v for example replaces the identifier of the blockchain, and components r and s replace the two zeros.

At a step 340 (“TRANSMIT TRANSACTION”) following step 330, electronic device 130, for example via the mobile application, transmits the signed transaction T1 to server 150 to perform the recording of the link on the blockchain.

At a step 350 (“SAVE SIG1”) following step 340, scripts written into the blockchain are for example executed. For example, these scripts form part of a digital contract, such as a smart contract, created and electronically signed by the entity marketing product 102. A verification is for example performed by the blockchain, by using one or a plurality of components of signature SIG1. For example, component v is used for ECDSA algorithms, or the r and s components are used for EdDSA algorithms, due to the exclusive ownership property. For example, the signature is used to compare an address of tag 110, which is for example extracted from public key C_PU, with an expected address associated with token TOKEN, characterized by an identifier. The address of tag 110 is for example obtained from its public key C_PU. The address for example corresponds to a hexadecimal number generated from the last 20 bytes of public key C_PU, which has undergone a cryptographic hashing, for example by the Keccak-256 algorithm. The identifier of token TOKEN is generated upon creation thereof, for example by the computer system of the entity marketing product 102.

If the address of tag 110 effectively corresponds to the expected address, and signature SIG1 is compliant, signature SIG1 is written into the blockchain. Thus, anyone having access to the data recorded on the blockchain and possessing public key C_PU associated with tag 110 can verify that product 102, provided with tag 110, effectively corresponds to token TOKEN. The data written on the blockchain cannot be modified or deleted, which ensures that the link between tag 110 and token TOKEN is irreversible. A product other than product 102, for example a counterfeit, cannot possess the tag 110 comprising the address and private key C_PR. Thus, only product 102 can generate signature SIG1. Further, token TOKEN is, for example, a soulbound token, irreversibly associated with the recipient's address. The transfer of token TOKEN, for example, is no longer usable after this association.

At a step 360 (“CONFIRMATION”), following step 350, a confirmation that the recording has been successfully completed is for example transmitted from server 150 to electronic device 130. The confirmation is for example accessible from the mobile application. Token TOKEN and its contents are then for example also available from the mobile application, which provides privileged means of communication between the entity marketing product 102 and its owner. In other embodiments, step 360 is omitted.

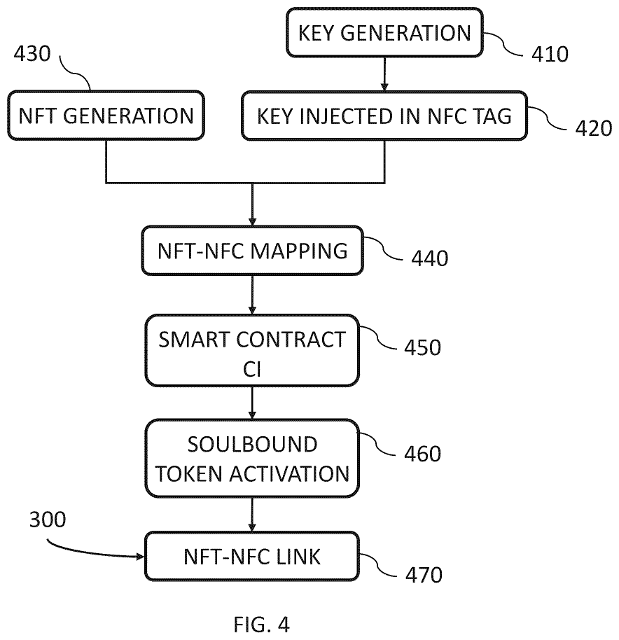

FIG. 4 shows steps of a method of recording the link between the tag 110 of FIG. 1 and the TOKEN token according to another embodiment of the present disclosure.

At a step 410 (“KEY GENERATION”), the pair of keys C_PR, C_PU is generated, for example during the manufacturing of tag 110.

At a step 420 (“KEY INJECTED IN NFC TAG”) following step 410, the generated pair of keys C_PR, C_PU is stored in the memory 112 of tag 110, for example by the manufacturer of tag 110.

At a step 430 (“NFT GENERATION”), token TOKEN is generated, for example by the computer system of the entity marketing product 102. The identifier of token TOKEN is for example generated at the time of the creation of token TOKEN.

The generation of token TOKEN for example comprises the adding of the content, for example images and/or metadata. For example, this content is stored in association with the identifier of token TOKEN on a decentralized server accessible by electronic device 130 and/or server 150, so that these devices can access the content.

At a step 440 (“NFT-NFC MAPPING”) following steps 420 and 430, the identifier of token TOKEN is assigned to the address of tag 110, for example by the computer system of the entity marketing product 102. A digital token such as token TOKEN is, for example, associated with a tag such as tag 110. According to an embodiment, a plurality of NFC tags similar to tag 110 can each be associated with the same collection of digital tokens. For example, product 102 is marketed in a plurality of items. Each item is then provided with a tag such as tag 110 with an address and a pair of keys unique among the items. Each item is for example associated with the same collection of digital tokens comprising information relative to product 102.

The match between the identifier of token TOKEN and the address of tag 110 is for example stored in a database on the IT system of the entity marketing product 102.

At a step 450 (“SMART CONTRACT”) following step 440, a smart contract CI is deployed on the blockchain, for example via a transaction signed by the IT system of the entity marketing product 102. The blockchain is for example a blockchain of ECC or Ed25519 type, for example a blockchain of Ethereum virtual machine (EVM) or Ethereum type. The Ethereum blockchain is for example described in the article “Ethereum: a secure decentralized generalized transaction ledger, paris version 705168a” by Dr. Gavin Wood or by the publication “Ethereum White Paper” by Vitalik Buterin, published in 2014 and updated on Dec. 8, 2023 (https://ethereum.org/fr/whitepaper/), the content of these publications being incorporated herein by reference. Smart contract CI comprises, for example, scripts executable by server 150 to cause the activation of tokens corresponding to physical objects (“Physical Backed Tokens-enabled”) by a function of constructor type on deployment of the smart contract on the blockchain. Smart contract CI for example comprises matches between token identifiers and NFC tag addresses, including the match between the identifier of token TOKEN and the address of tag 110. Smart contract CI for example also comprises scripts executable by server 150 to link a tag to a token, scripts executable by server 150 to record the belonging of product 102 to a user, scripts executable by server 150 to certify the authenticity of product 102, and/or scripts executable by server 150 to certify the belonging of product 102 to a user, etc.

At a step 460 (“SOULBOUND TOKEN ACTIVATION”) following step 450, token TOKEN is activated on the blockchain. A function of smart contract CI is executed so that the digital tokens, including token TOKEN, are bound to an account on a blockchain. After the execution of this function, token TOKEN can no longer be transferred to another account and/or another destination address, an Ethereum address for example.

At a step 470 (“NFT-NFC LINK”) following step 460, the steps of the method 300 of FIG. 3 are carried out.

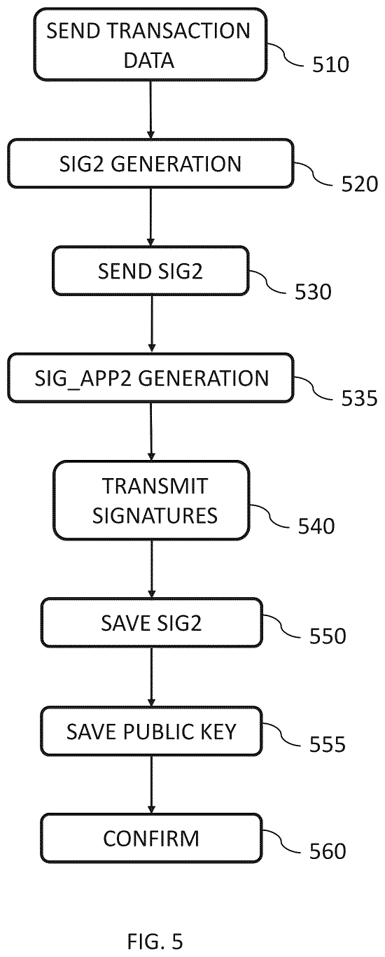

FIG. 5 shows steps of an example of a method of registration of an owner of the product 102 of FIG. 1 according to an embodiment of the present disclosure.

At a step 510 (“SEND TRANSACTION DATA”), a person, natural or legal, in possession of product 102 and of the electronic device 130 of FIG. 1 initiates a claim of ownership. For example, the person, via the mobile application, executes a request for a transaction T2 on the blockchain. Electronic device 130 sends to tag 110, by NFC, a signature request, corresponding to the transaction T2 on the blockchain. At step 510, electronic device 130 for example sends data by NFC to tag 110, the data for example forming part of the signature request and for example comprising data characterizing transaction T2.

Steps 520 (“SIG2 GENERATION”) and 530 (“SEND SIG2”) similar to the steps 320 and 330 of FIG. 3 are carried out after step 510 to generate a signature SIG2 and to send it to electronic device 130.

At a step 535 (“SIG_APP2 GENERATION”) following step 530, electronic device 130 generates a signature SIG_APP2 for transaction T2. Transaction T2 is, for example, signed by signatures SIG2 and SIG_APP2 in order to be valid. A pair of keys comprising a private key PRIV and a public key PUB is for example generated upon installation of the mobile application. According to an embodiment, signature SIG_APP2 is generated by electronic device 130 from private key PRIV, and public key PUB enables the verification of signature SIG_APP2.

At a step 540 (“TRANSMIT SIGNATURES”) following step 530, electronic device 130, for example via the mobile application, transmits signature SIG2 to server 150 to carry out transaction T2 on the blockchain. According to embodiments, transaction T2 comprises two signatures and electronic device 130, for example via the mobile application, also transmits signature SIG_APP2 to server 150. The use of multiple signatures SIG2 and SIG_APP2 increases the reliability of the transaction.

At a step 550 (“SAVE SIG2”) following step 540, scripts of smart contract CI are for example executed by server 150, and signature SIG2 is written into the blockchain. Thus, anyone having access to the data stored on the blockchain and possessing the public key C_PU associated with tag 110 will be able to verify transaction T2. The product 102 comprising tag 110 is then recorded as belonging to the user in possession of private key PRIV.

According to an embodiment, at a step 555 (“SAVE PUBLIC KEY”) following step 550, public keys C_PU and PUB are stored in a database of the computer system of the entity marketing product 102, for example via an oracle of the blockchain.

At a step 560 (“CONFIRM”), following step 555, a confirmation that transaction T2 has been successfully completed is for example transmitted from server 150 to electronic device 130. The confirmation is for example accessible from the mobile application.

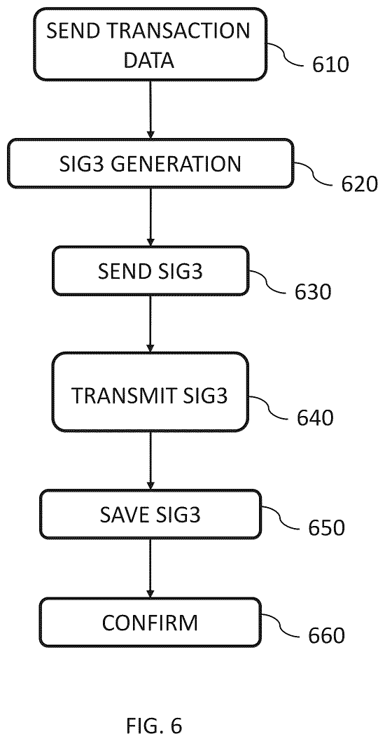

FIG. 6 shows steps of an example of a method of verification of the authenticity of the product 102 of FIG. 1, according to an embodiments of the present disclosure.

At a step 610 (“SEND TRANSACTION DATA”), a person, natural or legal, in possession of product 102 and of the electronic device 130 of FIG. 1 initiates a verification of the authenticity of product 102. For example, the person, via the mobile application, executes a request for a transaction T3 on the blockchain. Electronic device 130 sends to tag 110, by NFC, a signature request, corresponding to transaction T3 on the blockchain.

At step 610, electronic device 130 for example sends data by NFC to tag 110, the data for example forming part of the signature request and for example comprising data characterizing transaction T3.

Steps 620 (“SIG3 GENERATION”) and 630 (“SEND SIG3”) similar to the steps 320 and 330 of FIG. 3 are carried out after step 610 to generate a signature SIG3 and send it to electronic device 130.

At a step 640 (“TRANSMIT SIG3”) following step 630, electronic device 130, for example via the mobile application, transmits signature SIG3 to server 150 to perform transaction T3 on the blockchain.

At a step 650 (“SAVE SIG3”) following step 640, scripts of smart contract CI are, for example, executed by server 150 to check whether the address of tag 110 having initiated the transaction corresponds to an address associated with a digital token, for example an NFT token and/or a soulbound token, of the entity marketing product 102 and recorded on the smart contract, for example on deployment of smart contract CI by the entity marketing product 102, during the step 450 of FIG. 4.

At a step 660 (“CONFIRM”), following step 650, if the address on the tag 110 of product 102 effectively corresponds to an address associated with a digital token, for example an NFT token and/or a soulbound token, of the entity marketing product 102, then the tested product is considered as being authentic, and a confirmation of the authenticity of product 102 is, for example, transmitted from server 150 to electronic device 130. The confirmation is for example accessible from the mobile application.

In the case where product 102 is not authentic, it does not comprise tag 110. No signature SIG3 could be generated, or a signature corresponding to a private key different from key C_PR would be generated, and the transaction would not be validated.

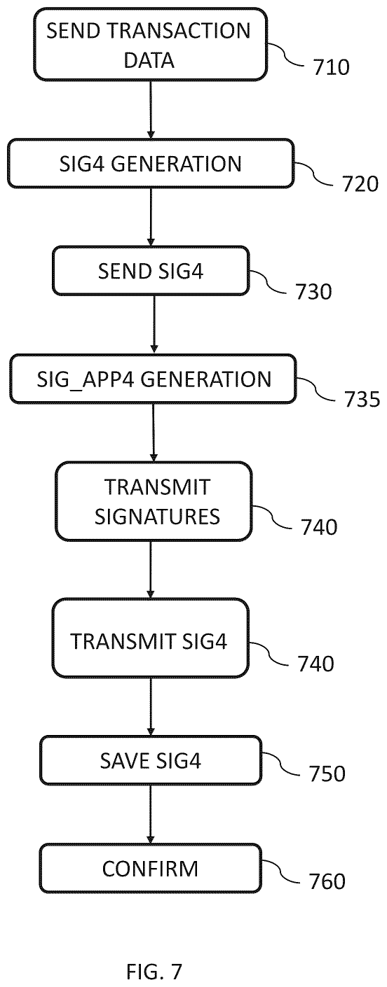

FIG. 7 shows steps of an example of a method of verification of the belonging of the product 102 of FIG. 1, according to an embodiment of the present disclosure.

At a step 710 (“SEND TRANSACTION DATA”), a person, natural or legal, in possession of the product 102 and of the electronic device 130 of FIG. 1 initiates a verification of the belonging of product 102. For example, the person, via the mobile application, executes a request for a transaction T4 on the blockchain. Electronic device 130 sends to tag 11, by NFC, a signature request, corresponding to transaction T4 on the blockchain.

During step 710, electronic device 130 for example sends data by NFC to tag 110, the data for example forming part of the signature request and for example comprising data characterizing transaction T4.

Steps 720 (“SIG4 GENERATION”) and 730 (“SEND SIG4”) similar to the steps 320 and 330 of FIG. 3 are performed after step 710 to generate a signature SIG4 and send it to electronic device 130.

At a step 735 (“SIG_APP4 GENERATION”) following step 730, electronic device 130 generates a signature SIG_APP4 for transaction T4. Transaction T4 is, for example, signed by signatures SIG4 and SIG_APP4 to be valid. According to an embodiment, signature SIG_APP4 is generated by electronic device 130 from private key PRIV.

At a step 740 (“TRANSMIT SIGNATURES”) following step 730, electronic device 130, for example via the mobile application, transmits signature SIG4 to server 150 to perform transaction T4 on the blockchain. According to embodiments, transaction T4 comprises two signatures and electronic device 130, for example via the mobile application, also transmits signature SIG_APP4 to server 150.

At a step 750 (“SAVE SIG4”) following step 740, scripts of smart contract CI are for example executed by server 150 to compare public keys PUB and C_PU with the public keys used during the registration of the owner of product 102 and recorded during the step 555 of FIG. 5. The recorded public keys are, for example, read from the database of the computer system of the entity marketing product 102, for example via an oracle of the blockchain. The comparison of public key C_PU and of public key PUB ensures that it effectively is the same product 102 and a user possessing the same electronic device 130 who performs transaction T4 as during the transaction T2 of FIG. 5.

At a step 760 (“CONFIRM”), following step 750, a confirmation of the belonging of product 102 is for example transmitted from server 150 to electronic device 130, if the pair of public keys C_PU, PUB is identical to that recorded in the database of the computer system of the entity marketing product 102 during the step 555 of FIG. 5. The confirmation is for example accessible from the mobile application.

The metadata of token TOKEN for example also include communications from the entity marketing product 102 to the owner of product 102 and accessible via the mobile application. The described methods allow a better information of consumers about the supply chain of their products.

According to one embodiment, the token TOKEN is a non-fungible token corresponding to the ERC721 standard, for example specified in the document “ERC-721: Non-Fungible Token Standard” written by William Entriken, Dieter Shirley, Jacob Evans and Nastassia Sachs, published in January 2018 (https://eips.ethereum.org/EIPS/eip-721), the content of this publication being incorporated herein by reference.

According to one embodiment, the token TOKEN comprises one or more images of the product 102, for example a digital twin of the product 102.

According to one embodiment, the token TOKEN is a SoulBound token. In this case, the token TOKEN cannot be transferred or disassociated from tag 110 in any way after the registration of a link between the tag 110 and the token TOKEN, as detailed in relation with FIG. 3. The tag 110 is the sole owner of this token. For example, ownership information is available on the blockchain and nothing is stored in the internal memory of the tag.”

Advantageously, the described embodiments use a NFC communication between product 102 and electronic device 130. This mode of communication over short distances is secure and passive on the side of product 102, which requires no electronic circuitry or battery. The disclosed solution is cost-effective and compatible with a wide variety of products. Finally, the described embodiments enable the generation, by product 102, of a three-component signature directly compatible with the blockchain.

Various embodiments and variants have been described. Those skilled in the art will understand that certain features of these various embodiments and variants may be combined, and other variants will occur to those skilled in the art.

1. A method of recording a link between a radio frequency tag and a token comprising data associated with a product, the method comprising:
sending, by near-field communication or radio frequency identification, of data of a transaction from an electronic device to the tag;
generating a signature of the data of the transaction by the tag based on a private key of an asymmetric pair of keys further comprising a public key, the signature being configured to enable a recording on a blockchain;
transmitting by the tag of the signed transaction to the electronic device by NFC or RFID; and
immutable recording the link between the tag and the token by a transmission, by the electronic device, of the signed transaction to a server implementing the blockchain.

2. The method of claim 1, wherein the signature comprises three components generated by a cryptographic signature algorithm, wherein a third component of which enables identification the public key.

3. The method of claim 1, wherein the signature comprises two components generated by a cryptographic signature algorithm, one of the two components identifying the asymmetric pair of keys.

4. The method of claim 1, wherein the immutable recording of the link between the tag and the token comprises execution by the server of scripts.

5. The method of claim 1, wherein sending the transaction data by the electronic device is performed via an application, the application being implemented by the electronic device and the recording of the link being initiated by the application.

6. The method of claim 1, wherein generating the signature is performed by an elliptic cryptography algorithm.

7. The method of claim 1, wherein the blockchain is of Ethereum virtual machine type.

8. A system for recording a link between a radio frequency tag and a token comprising data associated with a product, the device comprising:
an electronic device configured to send, by NFC or RFID, data of a transaction to the radio frequency tag, and configured to transmit the transaction signed to a server implementing a blockchain;
wherein the radio frequency tag is configured to generate a signature of the data of the transaction based on a private key, forming an asymmetric pair of keys comprising the private key and a public key;
wherein the signature is configured to enable a recording on a blockchain;
wherein the radio frequency tag is further configured to transmit, by NFC or RFID, the signature to the electronic device; and
wherein the electronic device is configured to transmit the signed transaction to the server implementing the blockchain and configured to immutably record the link between the radio frequency tag and the token.

9. The system of claim 8, wherein the signature comprises three components generated by a cryptographic signature algorithm, wherein a third component of which enables to identify the public key.

10. The system of claim 8, wherein the signature comprises two components generated by a cryptographic signature algorithm, one of the two components identifying the asymmetric pair of keys.

11. The system of claim 8, further comprising the server.

12. The system of claim 8, wherein the radio frequency tag is attached or integrated to the product.

13. The system of claim 8, wherein the data associated with the product are images, metadata, or images and metadata.
